(19) United States
(12) Patent Application Publication
(10) Pub. No.: US 2006/0235814 A1
(43) Pub. Date: Oct. 19, 2006

(54) METHOD FOR ISOLATING IMPROVEMENT OPPORTUNITIES FROM LINEAR PROGRAM OUTPUT

(75) Inventors: Alfred Degbotse, Colchester, VT (US); Brian T. Denton, Winooski, VT (US); Robert J. Milne, Jericho, VT (US); Robert E. Rice, Essex Junction, VT (US); James W. Waite, Swanton, VT (US)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(73) Assignee: INTERNATIONAL BUSINESS MACHINES CORPORATION, Armonk, NY (US)

(21) Appl. No.: 10/907,843

(22) Filed: Apr. 18, 2005

(51) Int. Cl. G06N 5/02

(52) U.S. Cl. 706/47

(57) ABSTRACT

The invention disclosed here is a method for isolating improvement opportunities based upon linear programming output. In particular, the invention allows the user to select variables and automatically connects those variables to their indirect variables and equations.

### BACKGROUND OF THE INVENTION

1. Field of the Invention

The present invention relates to computer implementable decision support systems for analyzing the output of a solution to a system of equations. General methodologies within this field of study include advanced planning systems, optimization and heuristic based algorithms, mathematical programming, linear programming, constraint based programming, and simulation.

2. Description of the Related Art

Linear programs (LP) are used for solving a variety of decision optimization problems in industries such as petroleum, steel, telecommunications, finance, data storage, and microelectronics. These problems are characterized by the need to intelligently allocate resources to achieve a mathematically expressed objective. Practical LPs may have thousands or even millions of decision variables and equations (constraints). User analysts run these LPs iteratively to improve the input and corresponding output files. Obviously, one type of input improvement is the correction of data errors. Another improvement is to adjust the objective function parameters to better correlate them with true business needs. One improvement uplifts the availability of tightly constrained resources. Often, it is only after analyzing the LP results that the business analyst knows how to adjust the LP's inputs or have the necessary business justification to warrant the acquisition of more resources. For example, the analyst may realize that overtime is required in a particular department only after seeing that the regular work schedule would result in late delivery of shipments to an important customer. The more iterations and analysis the analyst can perform during a planning cycle, the better the business results. Doing a thorough analysis within the allotted time is important when these large LPs are used to run an enterprise's operations.

Analyzing the output of large LPs is complicated. Typically, a user analyst wants to know why a key output variable does not have a higher (or lower) value. Yet that key output variable may depend on many interrelated variables and equations. Commercial software provides the ability to examine the equations containing a specified variable, and the variables contained within a specified equation, but it does not provide a method for guiding the search for a root cause associated with an optimal solution to an LP. It is only after identifying these root causes that the analyst is able to intelligently decide what action to take to mitigate the root causes. Due to limited analyst time in practice, many root causes go unexplored. It is therefore desirable to reduce the time required to analyze LP output.

The below-referenced U.S. Patents and other technical references disclose embodiments that were satisfactory for the purposes for which they were intended. The disclosures of both the below-referenced prior U.S. Patents, in their entireties, are hereby expressly incorporated by reference into the present invention for purposes including, but not limited to, indicating the background of the present invention and illustrating the state of the art: U.S. Pat. No. 5,971,585, “Best can do matching of assets with demand in microelectronics manufacturing,” Oct. 26, 1999; U.S. patent application Ser. No. 10/708,119, filed in early 2004 by Orzell et al., entitled “METHOD FOR IDENTIFYING PRODUCT ASSETS IN A SUPPLY CHAIN USED TO SATISFY MULTIPLE CUSTOMER DEMANDS” having IBM Docket No. BUR920030192US1; U.S. Pat. No. 6,341,240 B1, “Method of Allocating Work in Capacity Planning,” Jan. 22, 2002; U.S. Patent Application 2002/0065709 A1, “System for Analyzing Results of an Employee Survey to Determine Effective Areas of Organizational Improvement,” May 30, 2002; and Greenberg, H. J., 1993, Kluwer Academic Publishers, A Computer-Assisted Analysis System for Mathematical Programming Models and Solutions. A User's Guide for ANALYZE.

### SUMMARY OF INVENTION

The invention comprises a method for isolating improvement opportunities based upon linear programming equations and output. Although a key output variable may be implicitly linked to hundreds or thousands of equations and variables, only a small subset of these are of interest to the analyst. Only the relevant information from that search is output. As a result of using the invention, an analyst can quickly identify what he perceives as a root cause(s) of a key output variable's undesirably low (or high) value. Since analyst time is limited, reducing analyst time per inquiry results in better analysis. More root cause problems are identified leading toward more improvements in root causes resulting in greater enterprise success.

More specifically, the invention comprises a method, service, system, etc. for analyzing data output from a mathematical program, such as a linear program or resource allocation application. As shown in greater detail below, the invention establishes at least one rules table before analyzing the data output from the resource allocation application. Each rule in the rules table is associated with one of the output variables of the resource allocation application and each rule comprises a reference to an equation or inequality of the resource allocation application. The invention then obtains the output from the resource allocation application and explores the output variables using the rules table to produce an initial analysis. The invention can then repeat the processes of obtaining the output from the resource allocation application and exploring this output using different rules and/or different inputs to produce secondary analysis.

The actual “exploring” process comprises locating at least one rule that is associated with one of the output variables in the rules table, examining the equations of the resource allocation application that are referenced in rules identified by the locating process, and then reporting equations that contain broken chains and/or that have a measure outside a predetermined limit (variables whose value is “tight”).

When “examining” the equations, the invention determines if an equation comprises an equality or inequality. If the equation comprises an inequality, the invention determines if the inequality is outside the predetermined limit. If the value of the inequality is outside the predetermined limit, the inequality is considered to be tight and this fact is reported to the user. To the contrary, if the equation comprises an equality, the invention checks to see whether dependent variables exist. If dependent variables exist, the invention repeats the locating, examining, and reporting for each of the dependent variables (for both direct and indirect dependent variables). If the dependent variables do not exist, the invention reports the existence of a broken chain to the user.

When establishing the rules table, the invention allows the user to identify at least one equation to be examined for each output variable in the rules table, and dependent variables to be searched for each equation in the rules table. When establishing the rules table and/or when selecting one rule table over another rule table, the invention creates a subset of the output equation variables to be explored through the rules table, which reduces the volume of data presented to the user for analysis, thereby simplifying the analysis.

The invention is especially helpful during the period of time when new data is being put into a system. This will facilitate debugging of data when new product technologies are added and new applications introduced. The invention will speed up the time it takes to deploy new software since data debugging and scrubbing can be a major event.

The invention is applicable to many uses of linear programming such as those found in the petroleum, steel, telecommunications, pharmaceuticals, semiconductors, hard disk drives, and other manufacturing and distribution environments.

These, and other, aspects and objects of the present invention will be better appreciated and understood when considered in conjunction with the following description and the accompanying drawings. It should be understood, however, that the following description, while indicating embodiments of the present invention and numerous specific details thereof, is given by way of illustration and not of limitation. Many changes and modifications may be made within the scope of the present invention without departing from the spirit thereof, and the invention includes all such modifications.

### BRIEF DESCRIPTION OF THE DRAWINGS

FIG. 1 is a schematic drawing of a overview of the structure of a typical linear programming application followed by the invocation of the invention's logic;

FIG. 2 is a schematic drawing of a sample set of configuration rules;

FIG. 3 is a schematic drawing of a sample set of equations used in illustrating the invention;

FIG. 4 is a schematic drawing of a sample set of configuration rules mapping variables to explored equations;

FIG. 5 is a schematic drawing of a sample set of configuration rules mapping equations to explored variables;

FIG. 6 is a flowchart of the major steps involved in the invention;

FIG. 7 is a flowchart of the exploration steps involved in the invention;

FIG. 8 is a schematic drawing of another sample set of configuration rules; and

FIG. 9 is a schematic drawing of hardware embodiment of the invention.

### DETAILED DESCRIPTION OF THE PREFERRED EMBODIMENTS OF THE INVENTION

The present invention provides the capability to analyze the output of a mathematical program such as a resource allocation application or a linear program. To contrast the present invention, a conventional production planning linear program “LP” is discussed below (such as that described in U.S. Pat. No. 5,971,585, which is incorporated herein by reference). This LP makes decisions including: production starts, material substitutions, and shipments planned to customers, between manufacturing and distribution locations, and from vendor suppliers. An LP has an objective function that defines a measure of the quality of a given solution, and a set of linear constraints. The types of equations used in production planning models are well known to those practiced in the art and include: (1) Material Balance equations, which ensure conservation of material flow through the network of stocking points comprising the supply chain. (2) Capacity Constraints, which ensure that the capacity available for manufacturing activities is not exceeded. (3) Backorder Conservation Constraints, which balance the quantity of a given part backordered in a given planning period with the quantity backordered in the previous planning period and the net of new demand and new shipments. (4) Sourcing Constraints, which define target ranges (minimum and maximum) of shipments that should be made from a particular manufacturing or vendor location in the supply chain.

A conventional LP formulation is provided below in the form familiar to those practiced in the art; i.e., definition of subscripts, definition of objective function coefficients, definition of constants, definition of decision variables, LP formulation or equations.

Definition of Subscripts

j—time period

m—material (part number)

a—plant location within the enterprise

n—material being substituted

z—group (which represents a family or collection of part numbers)

e—process (a method of purchasing or manufacturing a material at a plant)

v—receiving plant location

k—demand center (i.e., customer location) (Note: the set of customer locations is mutually

exclusive from the set of plant locations)

q—demand class which indicates relative priority

w—resource capacity which could be a machine, labor hour, or other constraint

u—represents a consumer location which refers to an internal plant, external demand center, or to

a generic indicator meaning any plant/or demand center

Definition of Objective Function Coefficients

PRCⱼₘₐₑ—cost of releasing one piece of part m during period j at plant a using process e

SUBCⱼₘₙₐ—substitution cost per piece of part number n which is being substituted by part number m during period j at plant a

TCjₘₐᵥ—transportation cost per piece of part number m leaving plant a during period j which are destined for plant v

INVCⱼₘₐ—inventory cost of holding one piece of part number m at the end of period j at a particular plant a

DMAXC_{jzau}—cost per piece of exceeding the maximum amount of shipments of group z parts from plant a to consuming location(s) u during period j

DMINC_{jzau}—cost per piece of falling short of the minimum amount of shipments specified for group z parts from plant a to consuming location(s) u during period j

BOC_{jmkq}—backorder cost of one piece of part m at the end of period j for class q demand at customer location k

Definition of Constants

DEMAND_{jmkq}—demand requested during time period j for part number m at customer location k for demand class q

RECEIPTⱼₘₐ—quantity of projected wip and purchase order receipts for part number m expected to be received at plant a during time period j

CAPACITY_{jaw}—Capacity of resource w available at plant a during period j to support production starts

CAPREQ_{jmaew}—Capacity of resource w required for part number m at plant a for process e during period j

QTYPERⱼₘₐₑₙ—quantity of component m needed per part number n during period j at plant a using process e

YIELDⱼₘₐₑ—output of part number m per piece released or started at plant a during time period j using process e

SUBQTYⱼₘₙₐ—quantity of part number m required to substitute for one piece of part number n at plant a during time period j

MAXPCT_{jzau}—maximum percentage of total shipments of group z (collection of parts) leaving supplier a during period j to support consumption at consuming location(s) u

MINPCT_{jzau}—minimum percentage of total shipments of group z (collection of parts) leaving supplier a during period j to support consumption at consuming location(s) u

CTⱼₘₐₑ—Cycle time. The number of periods between the release and completion of part m jobs for releases made using process eat plant a during time period j

TTₘₐᵥ—transport time for part number m from plant a to plant v

Definition of LP Decision Variables

Iⱼₘₐ—Inventory at the end of period j for part number m at a particular plant a

Pⱼₘₐₑ—Production starts of part m during period j at plant a using process e

Lⱼₘₙₐ—Quantity of part number n which is being substituted by part number m during period j at plant a

Tⱼₘₐᵥ—Internal shipments of part number m leaving plant a during period j which are destined for plant v

F_{jmakq}—Shipments of part number m leaving plant a during period j and satisfying class q demand at external customer k

B_{jmkq}—Back orders of part m at the end of period j for class q demand at customer location k

H_{jzu}—Total shipments of group z (z is a “collection” of parts) leaving suppliers during period j to support consumption at consuming location(s) u

S_{jzau}—Amount by which total shipments of parts in z from plant a to consuming location(s) u during period j exceeds the maximum amount specified as desired in the sourcing rules

G_{jzau}—Amount by which total shipments of group z parts from plant a to consuming location(s) u during period j falls short of the minimum amount specified as desired in the sourcing rules

LP Equations or Formulation

The following minimizes the objective function subject to the constraints shown below.

Objective Function:

Minimize:

$${\sum }_{j} {\sum }_{m} {\sum }_{a} {\sum }_{e} {PRC}_{jmae} {P}_{jmae} + {\sum }_{j} {\sum }_{m} {\sum }_{n} {\sum }_{a} {SUBC}_{jmna} {L}_{jmna} + {\sum }_{j} {\sum }_{m} {\sum }_{a} {\sum }_{v} {TC}_{jmav} {T}_{jmav} + {\sum }_{j} {\sum }_{m} {\sum }_{a} {INVC}_{jma} {I}_{jma} + {\sum }_{j} {\sum }_{z} {\sum }_{a} {\sum }_{u} {DMAXC}_{jzau} {S}_{jzau} + {\sum }_{j} {\sum }_{z} {\sum }_{a} {\sum }_{u} {DMINC}_{jzau} {G}_{jzau} + {\sum }_{j} {\sum }_{m} {\sum }_{k} {\sum }_{q} {BOC}_{jmkq} {B}_{jmkq}$$

Subject to:

Sourcing Constraints:

$$\begin{matrix}{H}_{jzu} = {\sum }_{{m}_{ɛ z}} {\sum }_{a} ( {T}_{jmau} + {\sum }_{q} {F}_{jmauq} ) {\sum }_{{m}_{ɛ z}} ( {T}_{jmau} + {\sum }_{q} {F}_{jmauq} ) - \\ {S}_{jzau} \leq {MAXPCT}_{jzau} {H}_{jzu} {\sum }_{{m}_{ɛ z}} ( {T}_{jmau} + {\sum }_{q} {F}_{jmauq} ) + \\ {G}_{jzau} \geq {MINPCT}_{jzau} {H}_{jzu}\end{matrix}$$

Capacity Constraints:

$${\sum }_{m} {\sum }_{e} {CAPREQ}_{jmaew} {P}_{jmae} \leq {CAPACITY}_{jaw}$$

Backorder Constraints:

$${B}_{jmkq} = {B}_{( j - 1 ) mkq} + {DEMAND}_{jmkq} - {\sum }_{a} {F}_{jmakq}$$

Material Balance equations:

$${I}_{jma} = {I}_{( j - 1 ) ma} + {RECEIPT}_{jma} + {\sum }_{{xsi , t}_{x + {CT}_{xmae} = j}} {\sum }_{e} {YIELD}_{xmae} * {P}_{xmae} + {\sum }_{n} {L}_{jmna} + {\sum }_{{xs , t}_{x + {TT}_{mav} = j}} {\sum }_{v} {T}_{xmva} - {\sum }_{n} {SUBQTY}_{jmna} * {L}_{jmna} - {\sum }_{v} {T}_{jmav} - {\sum }_{k} {\sum }_{q} {F}_{jmakq} - {\sum }_{{nst , m}_{{isacomponent}_{of n}}} {\sum }_{e} {QTYPER}_{jmaen} {P}_{jnae}$$

Non-Negativity Constraints:

All
Xᵢⱼ≧0,

where X is a generic decision variable and ij etc. represent generic subscripts

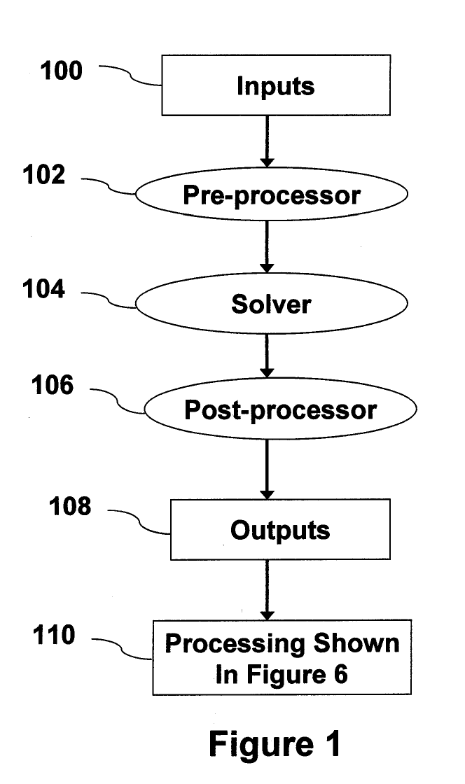

Linear programming applications include the transformation of input files (block 100) into output files (block 108) through a pre-processor (block 102), solver (block 104), and post-processor (block 106) as shown in FIG. 1. The pre-processor (block 102) transforms the raw input files into a form useable by the linear programming solver 104. The solver (block 104) determines an optimal raw output solution which is transformed by the post-processor (block 106) into a format acceptable for general usage.

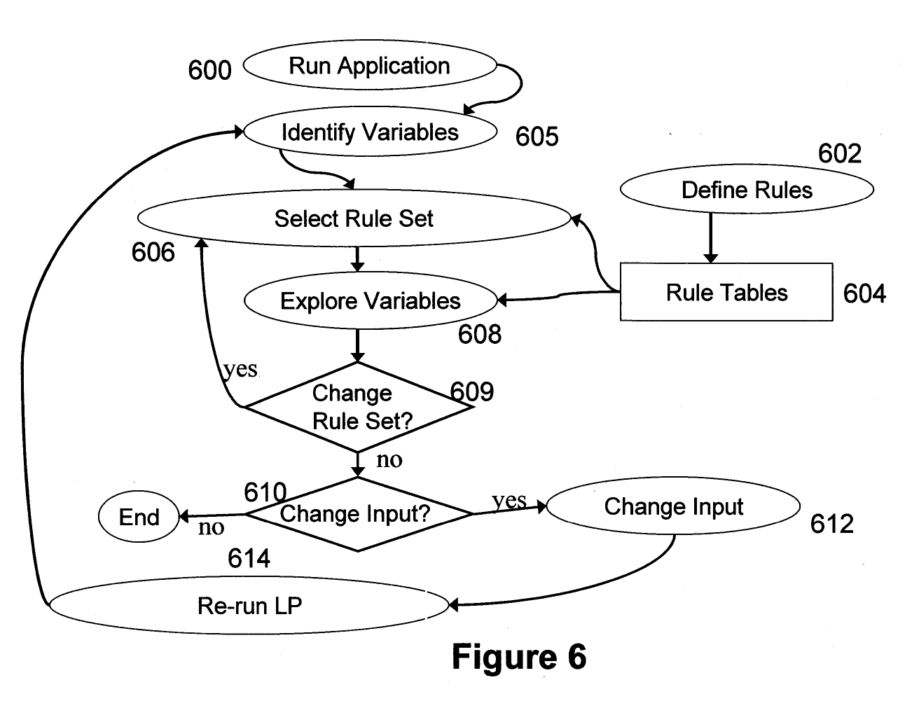

The present invention relates to a method for isolating improvement opportunities based upon linear programming output of the results of a linear programming solver 110. Consequently, the methodology processing shown in blocks 602-614 of FIG. 6 (block 110) would be invoked subsequent to the linear programming output being created (block 108).

The present invention is a method for isolating improvement opportunities based upon linear programming output. Although a key output variable may be implicitly linked to hundreds or thousands of equations and variables, only a small subset of these are of interest to the analyst. Configurable or table-driven “rules” guide the invention's search as it explores the small subset of paths an analyst would search. Only the relevant information from that search is output. As a result of using the invention, an analyst can quickly identify what he perceives as a root cause(s) of a key output variable's undesirably low (or high) value.

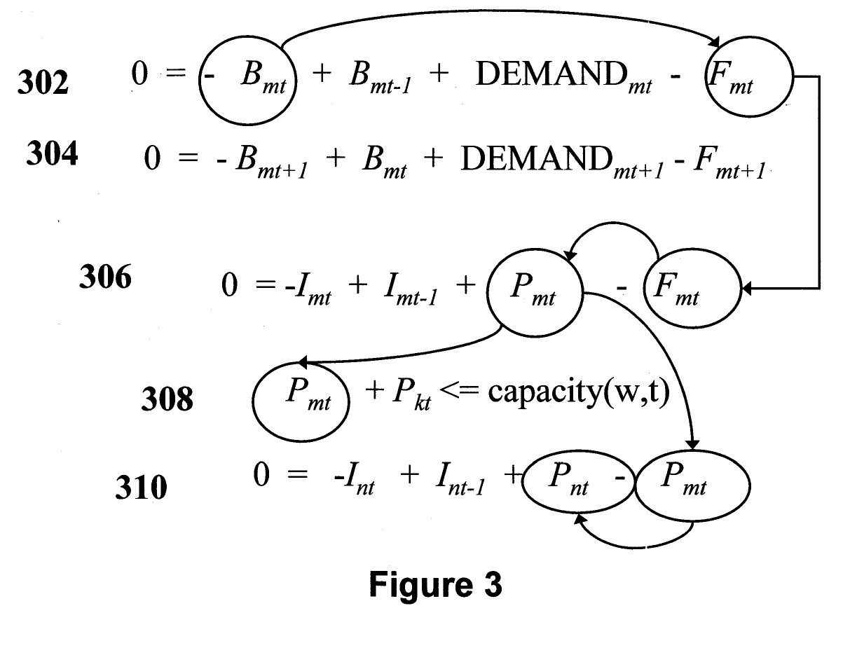

The following illustrates concepts of the present invention through a simplified example of a linear program (LP) used in production planning. The LP formulation of this example follows in a form familiar to those skilled in the art. More specific forms of some of the following general equations are shown in FIG. 3.

Definition of Subscripts

t—time period

m—material (part number)

n—component material (part number)

w—capacity resource

Definition of Objective Function Coefficients

PRCₘₜ—cost of releasing one piece of part m during period t

BOCₘₜ—backorder cost of one piece of part m at the end of period t

Definition of Constants

DEMANDₘₜ—demand requested during time period t for part number m

CAPACITY_{wt}—Capacity of resource w available during period t to support production starts

CAPREQ_{mw}—Capacity of resource w required per piece released of part number m

QTYPERₘₙ—quantity of component m needed per piece released of part number n

Definition of LP Decision Variables

Iₘₜ—Inventory at the end of period t for part number m

Pₘₜ—Production releases of part m during period t

Fₘₜ—Shipments of part number m during period t satisfying customer demand

Bₘₜ—Back orders of part m at the end of period t

LP Equations or Formulation

The following minimizes the objective function subject to the constraints shown below.

Objective Function:

Minimize:

$${\sum }_{m} {\sum }_{t} {PRC}_{mt} {P}_{mt} + {\sum }_{m} {\sum }_{t} {BOC}_{mt} {B}_{mt}$$

Subject to:

Capacity Constraint (wt):

$${\sum }_{m} {CAPREQ}_{mw} {P}_{mt} \leq {CAPACITY}_{wt}$$

Backorder Balance equation (mt):
0=−Bₘₜ+Bₘ₍ₜ₋₁₎+DEMANDₘₜ−Fₘₜ

Material Balance equation (mt): Fred, below I changed first subscript from (t−1) to t

$$0 = - {I}_{mt} + {I}_{m ( t - 1 )} + {P}_{mt} - {F}_{mt} - {\sum }_{{nst , m}_{{is a component}_{of n}}} {QTYPER}_{mn} {P}_{{n}_{t}}$$

Non-Negativity Constraints:

all
Xᵢⱼ≧0,

where X is a generic decision variable and ij etc. represent generic subscripts

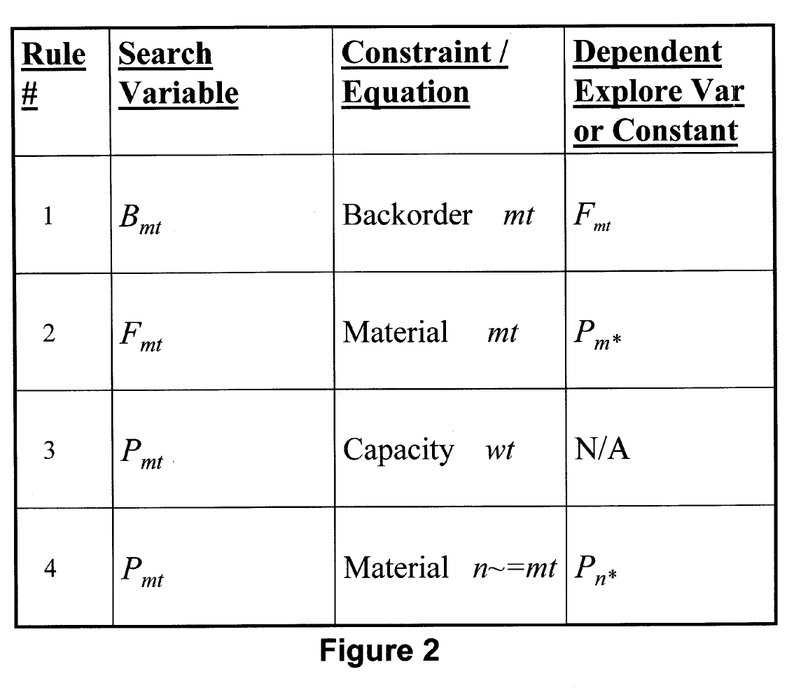

In one embodiment, the user is provided with a graphical user interface (GUI) which allows for selection of key output variable(s) as a function of what is likely to be important to the user in the particular problem domain. In this illustrative example, the GUI allows the user to easily select all backorder records which exceed a specified percentage of demand. In this case, the user may be interested in why the backorder variable (Bₘₜ) is too high. In most contexts, it would be obvious which direction—increase or decrease—the user would prefer the variable to move. In any event, the desired direction of the selected variable(s) would be specified according to a rule which is either preconfigured or selected by the user through a GUI. A user may also select a variable to explore after looking at any of a myriad of possible outputs of a linear programming run including but not limited to a set of equation or inequality constraints and the values of their variables (e.g. after examining a tight capacity constraint and the production consuming it). Once the variable(s) to be explored and their direction have been established, the invention searches/explores through the equations and related variables based on guidance from a configurable rules driven table such as the set of rules shown as an example in FIG. 2. The tables shown in the attached figures only illustrate a limited number of rules and one ordinarily skilled in the art would understand that the tables would include a substantially larger number of rules and that the rules could be related or unrelated. There may be thousands, even hundreds of thousands of constraints (equations and inequalities) in a large practical problem. The number of rules will be much smaller than the number of constraints.

The small number of related rules that are illustrated in the tables shown in the attached figures are dramatically simplified for purposes of explanation and are utilized to allow the reader to grasp the salient features of the invention, without inundating the reader with unnecessary voluminous content.

The configurable rules are set up based on the underlying structure of the linear program. The rules are related to the linear program's constraints and the decision variables. Two rules may be connected through the sharing of a common variable. An explored variable in the constraint of one rule may be the search variable of another rule. For example, the explored variable in the fourth column of rule 1 of FIG. 2 (Fₘₜ) is the same as the search variable in column two of rule 2.

Those skilled in the art will recognize that the backorder variable Bₘₜ is present in Backorder Balance equation (mt) 302 and Backorder Balance equation (mt+1) 304 shown in FIG. 3. Rule 1 of FIG. 2 indicates that variable Bₘₜ should be explored in Backorder Balance equation (mt) 302 and there are no rules indicating that Bₘₜ should be explored in Backorder Balance equation (mt+1) 304. More specifically, rule 1 requires that the Backorder Balance equation in the form Bₘₜ should be searched (equation 302) which filters out Backorder Balance equations that are not in the form Bₘₜ, such as equation 304. This is illustrated in FIG. 3 wherein Bₘₜ is circled in equation 302 but not 304. When the invention explores Bₘₜ it explores Backorder Balance equation (mt) 302 but does not explore the Backorder Balance equation (mt+1) 304. When exploring Backorder Balance equation (mt), rule 1 defines that dependent variable Fₘₜ should be explored. The beginning of this exploration is illustrated by the arrow connecting Bₘₜ in 302 to Fₘₜ in 302. The rules table shown in FIG. 2 includes a rule for exploring variable Fₘₜ (rule 2). While the rule for exploring the variable Fₘₜ is shown as the second rule in the rule table of FIG. 2, this rule could be located anywhere within the table as the invention will search the entire table and apply all rules that allow the variable in question to be explored. Rule 2 indicates that all material constraint equations (mt) should be searched for the variable Fₘₜ. Notice that the subscripts m and tin column 3 of FIG. 2's rule 2 mean that only material constraint equations (mt) will be searched (e.g. will not search mt−1). This searching locates equation 306. This is illustrated by the arrow connecting Fₘₜ in 302 to Fₘₜ in 306.

The motivation for connecting Bₘₜ to the customer shipment variable Fₘₜ in the rule table is that the user analyst will not be interested in exploring Bₘ₍ₜ₋₁₎ or DEMANDₘₜ (see the general form of the backorder balance equation shown above). When establishing the rule table shown in FIG. 2, the analyst decided that he only wanted to explore the Fₘₜ variable to analyze why there weren't more customer shipments of that part number m in that time period t. It is the preconfigured rule 1 in FIG. 2 which defines this user preference. By defining/configuring these rules one time, such as illustrated in FIG. 2, the invention is able to explore the equation state space many times (according to these rules) without the need for the user analyst to specify the rules configuration more than the one time set up. Because the user specified that he wants to know why Bₘₜ is not lower and because Bₘₜ has the same sign (a negative sign) in front of it in equation 302 as that of Fₘₜ, it follows that the user wants to know why Fₘₜ is not higher. In the hypothetical situation where the variables had different signs in front of them in a shared equation, the user preference for one variable being decreased (increased) would indicate a preference for the other variable being decreased (increased).

If there are no customer shipment variables (Fₘₜ) in the Backorder Balance equation (mt) for part number m, then the invention would notify the analyst of this fact. This would indicate that it is not possible to ship the part number to satisfy the demand (i.e. a broken supply chain). Those skilled in the art will recognize the merit of identifying broken supply chains in a realistic supply chain planning application with multiple manufacturing plants and multiple demand locations. Other items causing broken supply chains would include: incomplete/incorrect manufacturing build data, incorrect substitutions, lack of valid shipping relationship between plants and incorrect part number data.

When establishing the rule table shown in FIG. 2, of the variables in 306, Pₘₜ is the only one that the analyst has decided to explore. Rule 2 indicates as much and thus the inventory variables (Iₘₜ, Iₘₜ₋₁) of equation 306 are not explored. The absence of a Pₘₜ in 306 would indicate either that the supply chain is “broken” or that the cycle time required to manufacture product m is too long to complete production by period t. If there are production variables in 306 with positive coefficients only for some period s>t (i.e. material balance constraint ms), then the problem is that the cycle time to manufacture the product is too long to avoid the backorder. In either of these missing production variable situations, the relevant information as to the problem cause is displayed to the analyst. Given that variable Pₘₜ is present in 306, suppose that production of part m consumes capacity resource wand material inventory of component n. These latter two relationships would be instantiated and illustrated by the presence of Pₘₜ in capacity constraint 308 and material balance equation 310. Rules 3 and 4 of FIG. 2 indicate that Pₘₜ should be explored in those equations. The arrows in FIG. 3 illustrate the exploration.

The dependent variables can be direct or indirect. Direct dependent exploration variables are those connected directly to the variable in a rule whereas indirect dependent variables are those which are not direct but are connected through the path (as illustrated by the arrows in FIG. 3). Thus, indirect dependent variables are connected to the initially specified output variable by its supporting dependent constraints and dependent variables through the search exploration. For example, as shown in rule 1 in FIG. 2, Fₘₜ is a direct dependent variable of the constraint of Backorder (mt), while P_{m*} is an indirect dependent variable that is only dependent on Backorder (mt) by virtue of rules 1 and 2.

Equation 310 is another material balance equation and is explored in a similar manner to material balance equation 306. As for equation 308, for ease of illustration and without loss of generality, assume that CAPREQ_{jw} is unity for all material part numbers j. If equation 308 is “loose” (i.e. the capacity is underutilized), then the invention does not display any information about this equation to the analyst. On the other hand, if the equation is “tight” (i.e. capacity fully utilized or above a predetermined level), the analyst will want to know that information so the (rules driven) invention will provide it. The information may be in the form of a graph showing the required capacity versus the available capacity over the relevant time frame. Optionally, the analyst can become aware of the other production competing for that capacity such as positive values of Pₖₜ and potentially the end-item demand being supported by that competing production. This latter point could exploit the “demand pegging” concept referenced in U.S. patent application Ser. No. 10/708,119, which may only be applicable in a supply chain context.

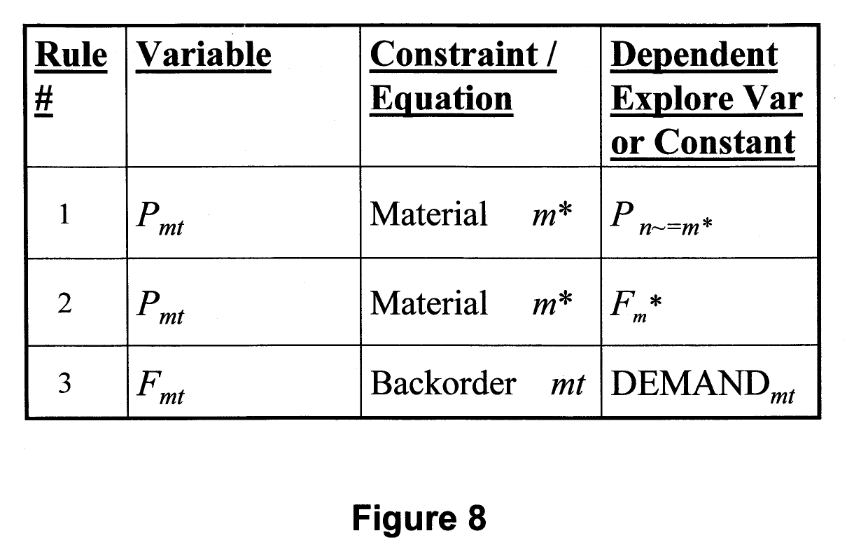

Another approach is to switch the search to another set of rules which would enable the exploration of competing production variable(s) back to the backorder variables driving that competing production. A set of sample configuration rules which could be used in this type of exploration is illustrated in FIG. 8. More specifically, rule 1 in the table shown in FIG. 8 looks for any material constraint for equation in the form m* (where * is a wildcard encompassing all variables) with a dependent variable or constraint be explored in the form P_{n˜=m*}. As would be understood by one ordinarily skilled in the art, the variable P_{n˜=m*} in column 4 of FIG. 8's rule 1 encompasses Pₘₜ in the second column of rule 2 of FIG. 8 and in fact leads to the exploration of said rule 2. In utilizing the FIG. 8 set of rules, the production of the competing variable is traced forward through its bills of materials supply chain (using rule 1 of FIG. 8) until a production variable is found in a material balance equation with a customer shipment (rule 2 of FIG. 8) and subsequently the demand driving it (using rule 3 of FIG. 8).

In addition to displaying the root cause constraint(s), at the analyst's discretion, the invention will display information on the pathway taken from the key output variable to the root constraint(s). This display can appear as the listings of equations (as shown in FIG. 3) with or without circles and arrows, can comprise a listing of just the variables explored (with or without their values), or any other similar display as found by the user to provide the easiest form of analysis. In the case of multiple paths to the same constraint, at the analyst's option, only the predominant one—that with the displayed variable of highest percentage or relative value—will be displayed.

After the analyst sees potential root causes, he may desire to change some values of the linear program and re-run to see the impact. This what-if capability will reveal the impact of the change on all key output variables of interest (which may include resultants in addition to those explicitly requested).

Recognize that the above small-scale example was used for the purposes of explanation. Practical large-scale models may involve millions of variables and constraints. Therefore, accurate and timely analysis of such models necessitates the use of a formal and systematic method of analysis such as that described herein.

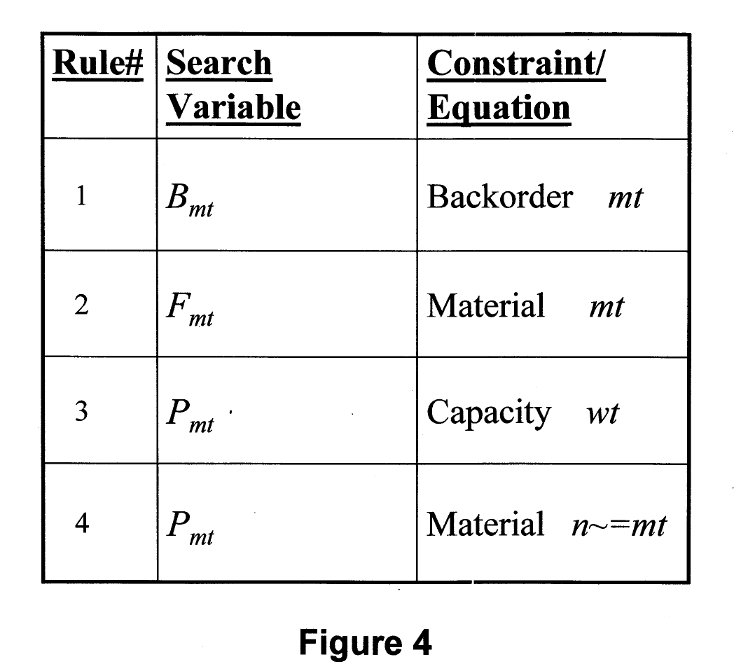

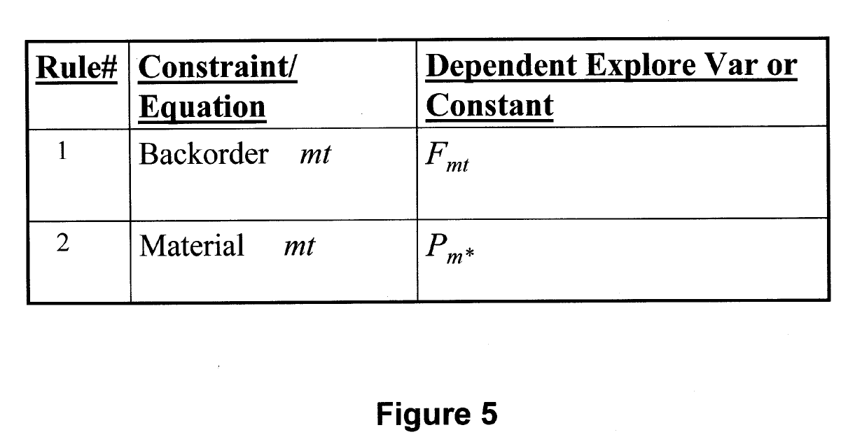

Those skilled in the art will recognize that the set of configurable rules specified in the table of FIG. 2 could be normalized into the tables shown in FIGS. 4 and 5. Thus, FIGS. 4 and 5 can be considered tables that included only a portion of the information contained within the table shown in FIG. 2. More specifically, the table shown in FIG. 4 only includes a rule number, variable, and related constraint (equation or inequality) to be evaluated. Alternatively, the table shown in FIG. 5 only includes a rule number, a constraint or equation to be explored, and a dependent variable or constant for which a following rules should be searched. Using these normalized tables in place of the table of FIG. 2 would be straightforward to those skilled in the art. For instance, rule 1 of FIG. 4 and rule 1 of FIG. 5 together can be used to apply the logic used when applying rule 1 of FIG. 2 in the alternative embodiment. The application context determines whether it is preferable to use the embodiment of FIG. 2 or the normalized embodiment of FIGS. 4 and 5. Generally speaking, in contexts where many variable types explore each equation type, the normalized embodiment would be preferable whereas contexts exploring a single variable type per equation type the un-normalized embodiment of FIG. 2 would generally be preferable. An ideal software package practicing the invention would provide an option to utilize either embodiment.

Exemplary steps of the inventive method/service that analyzes output from the linear program are illustrated in FIG. 6. In 600, a resource allocation application (used in such industries as petroleum, steel, telecommunications, finance, data storage, and microelectronics to intelligently allocate resources to achieve a mathematically expressed objective) such as advanced planning systems, optimization and heuristic based algorithms, mathematical programming, linear programming (LP), and constraint based programming is executed using the steps summarized in blocks 100-108 of FIG. 1 to produce an output containing variables and their corresponding values. The remainder of this embodiment refers to an LP being used for purposes of illustration though those skilled in the art will recognize that other resource allocation applications could be used.

In 602, an analyst will define/configure (establish) sets (tables) of rules used in controlling the exploration/search of the equation state space to establish the rule table or tables (e.g., FIGS. 2, 4, 5, and 8). Each rule in the rules table is associated with one of the output variables of the resource allocation application and each rule comprises a reference to an equation of the resource allocation application. When establishing the rules table, the invention allows the user to identify at least one equation to be examined for each output variable in the rules table, and at least one dependent variable to be searched for each equation in the rules table. When establishing the rules table and/or when selecting one rule table over another rule table, the invention creates a subset of the output equation variables to be explored through the rules table, which reduces the volume of data presented to the user for analysis, thereby simplifying the analysis. These rule tables are stored in block 604. It is not necessary for the analyst to do this every time the linear program is executed in step 600. Block 602 can, for example, be executed as a one time set up (for each set of exploration rules) or can be performed as changes to the configurable exploration rules are required.

In block 605, the user or analyst will identify output variables output by the application in 600 that the user or analyst would like to explore. Generally, these may be key output variables, that is, decision variables which are important as to characterizing the acceptability of an LP run from a business perspective. In the example presented above, the backorders were the most important variables from a user view since they indicated unsatisfied demand. A Graphical User Interface (GUI) provides the user with the ability to select variable(s) as a function of various selection criteria. The selection criteria may be by variable type, relative magnitude (small or large percentage), subscript, subscript range (e.g., all dates within October of the present year), or another criterion such as the earlier mentioned selection of backorder variables as a function of percentage of demand backordered. In block 605, it can also be specified as to whether the user wants the key output variable's value to increase or decrease. Generally, this will be pre-determined by context rather than prompting the user each time as to whether an increase or decrease is desired. When there are a plurality of exploration rule tables which may apply to the selected variable(s), block 606 allows the user to select one. When there is only a single set of exploration rules which may apply to the selected variable(s), the selection of the set (table) is done automatically. Optionally, the user may decide that the exploration/search should only output solution paths which have positive values of all variables along the path; this selection would be done in 605 and would allow the user analyst to filter out dead paths from the output; however, the user analyst would generally want to see paths with zero values of variables and this embodiment of this invention is described accordingly.

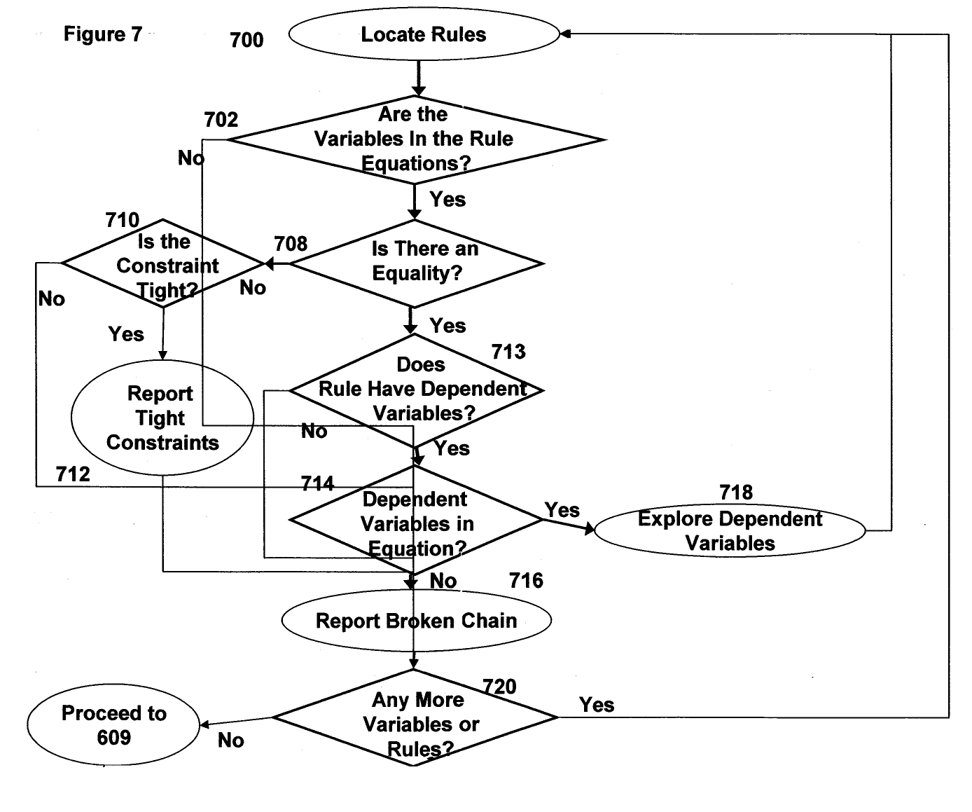

Block 608 explores the variables selected by the user analyst in 605 by applying the rules of 604 according to the rule set determined in 606. Thus, the invention obtains the output from the resource allocation application and explores the output variables (either one at a time or in parallel) using the rules table to produce an initial analysis. For each variable explored in 608, the steps in FIG. 7 are executed. As an overview, the actual “exploring” process comprises locating at least one rule that is associated with one of the output variables in the rules table, examining the equations of the resource allocation application that are referenced in rules identified by the locating process, and then reporting equations that contain broken chains and/or are at full capacity (that have a measure outside a predetermined limit) having variables whose value is tight.

More specifically, block 700 locates all rules associated with one of the variables within the output of the resource allocation application according to the rules defined in block 604. Block 702 examines each equation/constraint in the resource allocation application that is associated with the currently explored variable according to the current rule. For those equations (called for by the rule/variable currently being explored that are located within the resource allocation application) that contain the selected variable, the invention executes block 708 for each such variable. If the variable output by the resource allocation application currently being explored is not located within the rule table chosen by the user, processing proceeds to item 720 determine whether any additional rule and/or variables are remaining to be evaluated. If additional variables remain, processing returns to item 700 to attempt to locate rules associated with the remaining variables within the selected rule table or tables.

If a rule for the variable being currently explored is found in the rule table in item 702, processing proceeds to item 708 to examine the equations in the resource allocation application. When “examining” the equations of the resource allocation application, the invention determines if the equation comprises an equality or inequality. Thus, block 708 checks to see whether the constraint/equation corresponding to the rule is an equality or inequality constraint and invokes 710 (inequality) or 713 (equality) accordingly.

If the equation comprises an inequality, the invention determines if the inequality is outside a predetermined limit (e.g., is too high or too low (either at 100% capacity, 90% capacity, 80% capacity, etc., or 0% availability capacity, 10% available capacity, 20% available capacity) either as an absolute value or a relative value, such as a percentage or ratio) in block 710. If the value of the inequality is outside the predetermined limit, the inequality is considered to be “tight” (as opposed to loose) and this fact is reported to the user. If the inequality is within the predetermined limit (is loose) this would normally indicate an acceptable condition and therefore no report of a loose inequality is generally reported to the user. Thus, for inequality constraints, block 710 checks whether the constraint is “tight” (i.e. no slack or surplus). If the constraint is tight, block 712 outputs the relevant information on that tight constraint to the user. If the constraint is loose, processing again returns to item 720 to process any remaining rules and/or variables.

To the contrary, if the equation comprises an equality, the invention checks to see whether the rule has dependent variables in block 713. If the rule does not include dependent variables, processing again returns to item 720 to process any remaining rules and/or variables. If the rule does include dependent variables, block 714 checks whether the direct dependent variable of the constraint is present in the equation of the resource allocation application that is called for by the specific rule being currently applied from the rule table. If dependent variables exist, the invention repeats the locating, examining, and reporting for each of the dependent variables (for both direct and indirect dependent variables) as shown by item 718 which returns processing to item 700. If the dependent variables do not exist, the invention reports the existence of a broken chain to the user in item 716, after which processing again returns to item 720 determine whether any additional rules and/or variables are to be explored. Thus, if there is no direct dependent variable for the constraint (as determined by 714), then 716 indicates to the user analyst that the chain (path) is broken, a broken supply chain being one example. If block 714 determines that a direct dependent variable exists, then it is explored through 718 which repeat the steps of FIG. 7 (beginning with step 700) recursively.

When outputting information (to a GUI, file, or data base), the invention will display or record the original key output variable, the root cause information on the constraint or broken supply chain, and optionally the path connecting the key output variable to the possible root cause(s) at the discretion of the user analyst. In one embodiment, the GUI will display the output path in a manner so that the user may easily explore any point on that path according to one-step-at-a-time ad hoc methodology.

Referring back to FIG. 6, after examining the output from the exploration of variables in 608, block 609 checks to see whether the user wants to change the exploration rule set and if so, returns control to 606. Otherwise, 609 passes control to 610 which checks whether the user wants to change any input(s) to the linear program as a result of the search exploration. If the user wants to change input, this is done in 612. After all input changes have been completed, the linear program is re-run with the revised input in 614. Subsequent to the completion of the re-run linear program, control returns to 605 where the user analyst has the opportunity to identify variables to explore under the revised linear programming output solution.

In addition, one embodiment would allow the user to trace quantity implications through the equations. When a variable is selected by the user in 605, the user may optionally specify a desired value for the magnitude of the desired change in the variable. This initial quantity is multiplied by the coefficients of the explored variables as the invention traverses the equations. The product resulting from these multiplications may be useful information to display as output to the user so as to provide insight into the magnitude of the root cause problem. For example, suppose the user specified a desired reduction of 200 pieces in the backorders of a finished module and that the backorder is caused by limited capacity of wafer releases. Adjusting for cumulative yield losses and chips per wafer conversions, those 200 pieces of finished modules may be supplied through, say, five wafer releases. Those yields and chips per wafer would be expressed as coefficients in the LP. Consequently, the method may calculate that the 5 pieces of additional wafers released would be enough to reduce the module backorder by 200 pieces.

The steps for implementing the present invention can be programmed in Java and C/C++. It should be understood by those of ordinary skill in the art, however, that the present invention is not limited to the above implementation and is independent of the computer/system architecture. Accordingly, the present invention may equally be implemented on other computing platforms, programming languages and operating systems, and also may be hardwired into a circuit or other computational component.

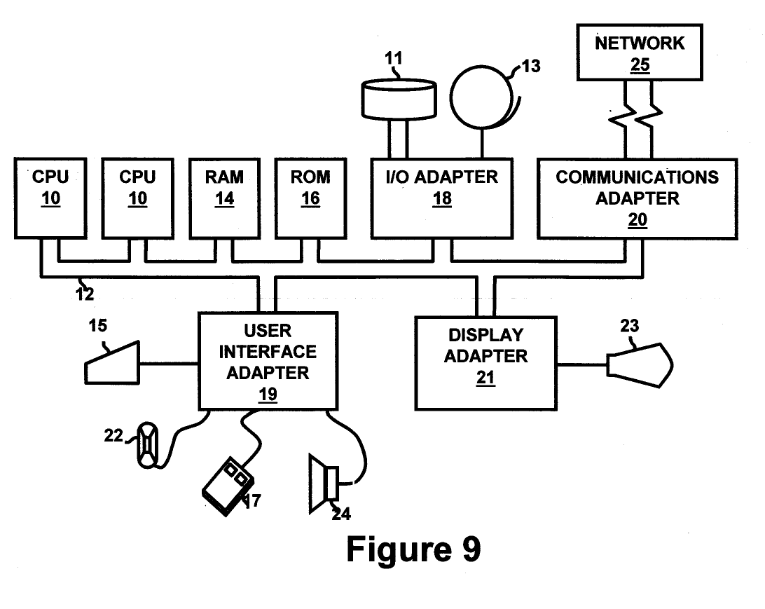

A representative hardware environment for practicing the embodiments of the invention is depicted in FIG. 9. This schematic drawing illustrates a hardware configuration of an information handling/computer system in accordance with the embodiments of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

Thus, as shown above, the invention presents a method for analyzing the output of a solution to a system of equations such as a linear program that provides a set of user selected variables and applies a set of (configurable) rules which connect the variables to their indirect dependent variables and then provides the dependent variables. This also encompasses providing information associated with the equations containing the dependent variable. The invention eliminates from user view inequalities which are loose. Further, the invention can identify variables which compete against a binding inequality and peg the variables to their end-item demand priority. The invention is specially adapted to perform “what-if” scenarios by allowing changes of the inputs to the system and then a re-running of the method which solves the system of equations. Further, the invention allows switching from one set of rules to another in order to switch directions of the exploration (e.g. switching from an “explosion” to an “implosion” or vice versa) when selecting which rules table to apply.

The invention can easily interact with commercial software, where solutions from such commercial software are fed directly to the tool and provide the ability detect a broken chain/path, and identify bottlenecks. Further, the invention provides the opportunity to make comparisons when exploring inequality constraints, such as comparisons between expected and actual values, as well as the ability to search/explore a plurality of paths and compute quantity implications.

While the invention has been described in terms of the embodiments, those skilled in the art will recognize that the invention can be practiced with modification within the spirit and scope of the appended claims.

What is claimed is:

1. A method of analyzing data output from a computerized mathematical program, said method comprising:
establishing at least one rules table;
identifying at least one dependent variable to be searched for each equation in said rules table;
obtaining output from said mathematical program, wherein said output comprises output variables and their values, and wherein at least one rule in said rules table is associated with one of said output variables and each said rule comprises a reference to an equation or inequality of said mathematical program;
locating at least one rule that is associated with an output variable of said output variables in said rules table;
examining items of said mathematical program that are referenced in rules identified by said locating process; and
reporting items that contain at least one of broken chains or that have a measure outside a predetermined limit based on said examining process.

2. The method according to claim 1, wherein said process of establishing said rules table comprises identifying at least one equation to be examined for each output variable in said rules table.

3. The method according to claim 1, further comprising searching said rules table for said dependent variable.

4. The method according to claim 1, further comprising selecting a subset of said output variables to be explored through said rules table.

5. The method according to claim 1, wherein said examining of said items comprises:
determining if an equation comprises an equality;
if said equation comprises an inequality, determining if said inequality is outside said predetermined limit; and
if said equation is an equality, determining if dependent variables exist.

6. The method according to claim 5, wherein if said dependent variables exist, repeating said locating, said examining, and said reporting for said dependent variables, and
wherein if said dependent variables do not exist, reporting a broken chain.

7. A method of analyzing data output from a computerized mathematical program, said method comprising:
establishing at least one rules table;
identifying at least one dependent variable to be searched for each equation in said rules table;
obtaining output from said mathematical program, wherein said output comprises output variables, and wherein each rule in said rules table is associated with one of said output variables and each said rule comprises a reference to an equation of said mathematical program; and
exploring said output variables using said rules table to produce an analysis;
wherein said exploring comprises:
locating at least one rule that is associated with an output variable of said output variables in said rules table;
examining equations of said mathematical program that are referenced in rules identified by said locating process; and
reporting equations that contain at least one of broken chains and that have a measure outside a predetermined limit based on said examining process.

8. The method according to claim 7, wherein said process of establishing said rules table comprises identifying at least one equation to be examined for each output variable in said rules table.

9. The method according to claim 7, further comprising searching said rules table for said dependent variable.

10. The method according to claim 7, further comprising selecting a subset of said output variables to be explored through said rules table.

11. The method according to claim 7, wherein said examining of said equations comprises:
determining if an equation comprises an equality;
if said equation comprises an inequality, determining if said inequality is outside said predetermined limit; and
if said equation is an equality, determining if dependent variables exist.

12. The method according to claim 11, wherein if said dependent variables exist, repeating said locating, said examining, and said reporting for said dependent variables, and
wherein if said dependent variables do not exist, reporting a broken chain.

13. A method of analyzing data output from a linear program, said method comprising:
establishing at least one rules table;
identifying at least one dependent variable to be searched for each equation in said rules table;
obtaining output from said linear program, wherein said output comprises output variables, and wherein each rule in said rules table is associated with one of said output variables and each said rule comprises a reference to a linear program equation of said linear program;
exploring said output variables using said rules table to produce an initial analysis; and
repeating at least one of said obtaining process and said exploring process using at least one of different rules and different inputs to said linear program to produce a secondary analysis,
wherein said exploring comprises:
locating at least one rule that is associated with an output variable of said output variables in said rules table;
examining linear program equations of said linear program that are referenced in rules identified by said locating process; and
reporting linear program equations that contain at least one of broken chains and that have a measure outside a predetermined limit based on said examining process.

14. The method according to claim 13, wherein said process of establishing said rules table comprises identifying at least one linear program equation to be examined for each output variable in said rules table.

15. The method according to claim 14, further comprising searching said rules table for said dependent variable.

16. The method according to claim 13, further comprising selecting a subset of said output variables to be explored through said rules table.

17. The method according to claim 13, wherein said examining of said linear program equations comprises:
determining if a linear program equation comprises an equality;
if said linear program equation comprises an inequality, determining if said inequality is outside said predetermined limit; and
if said linear program equation is an equality, determining if dependent variables exist.

18. The method according to claim 17, wherein if said dependent variables exist, repeating said locating, said examining, and said reporting for said dependent variables, and
wherein if said dependent variables do not exist, reporting a broken chain.

19. A service of analyzing data output from a computerized mathematical program, said service comprising:
establishing at least one rules table;
identifying at least one dependent variable to be searched for each equation in said rules table;
obtaining output from said mathematical program, wherein said output comprises output variables, and wherein each rule in said rules table is associated with one of said output variables and each said rule comprises a reference to an equation of said mathematical program;
locating at least one rule that is associated with an output variable of said output variables in said rules table;
examining items of said mathematical program that are referenced in rules identified by said locating process; and
reporting items that contain at least one of broken chains and that have a measure outside a predetermined limit based on said examining process.

20. The service according to claim 19, wherein said process of establishing said rules table comprises identifying at least one equation to be examined for each output variable in said rules table.

21. The service according to claim 20, further comprising searching said rules table for said dependent variable.

22. The service according to claim 19, further comprising selecting a subset of said output variables to be explored through said rules table.

23. The service according to claim 19, wherein said examining of said items comprises:
determining if an equation comprises an equality;
if said equation comprises an inequality, determining if said inequality is outside said predetermined limit; and
if said equation is an equality, determining if dependent variables exist.

24. The service according to claim 23, wherein if said dependent variables exist, repeating said locating, said examining, and said reporting for said dependent variables, and
wherein if said dependent variables do not exist, reporting a broken chain.

25. A program storage device readable by machine, tangibly embodying a program of instructions executable by said machine for performing a method of analyzing data output from a computerized mathematical program, said method comprising:
establishing at least one rules table;
identifying at least one dependent variable to be searched for each equation in said rules table;
obtaining output from said mathematical program, wherein said output comprises output variables, and wherein each rule in said rules table is associated with one of said output variables and each said rule comprises a reference to an equation of said mathematical program;
locating at least one rule that is associated with an output variable of said output variables in said rules table;
examining equations of said mathematical program that are referenced in rules identified by said locating process; and
reporting equations that contain at least one of broken chains and that have a measure outside a predetermined limit based on said examining process.

26. The program storage device according to claim 25, wherein said process of establishing said rules table comprises identifying at least one equation to be examined for each output variable in said rules table.

27. The program storage device according to claim 26, further comprising searching said rules table for said dependent variable.

28. The program storage device according to claim 25, further comprising selecting a subset of said output variables to be explored through said rules table.

29. The program storage device according to claim 25, wherein said examining of said equations comprises:
determining if an equation comprises an equality;
if said equation comprises an inequality, determining if said inequality is outside said predetermined limit; and
if said equation is an equality, determining if dependent variables exist.

30. The program storage device according to claim 29, wherein if said dependent variables exist, repeating said locating, said examining, and said reporting for said dependent variables, and
wherein if said dependent variables do not exist, reporting a broken chain.

31. A system for analyzing data output from a computerized mathematical program comprising:
means for establishing at least one rules table;
means for identifying at least one dependent variable to be searched for each equation in said rules table;
means for obtaining output from said mathematical program, wherein said output comprises output variables, and wherein each rule in said rules table is associated with one of said output variables and each said rule comprises a reference to an equation of said mathematical program;
means for locating at least one rule that is associated with an output variable of said output variables in said rules table;
means for examining equations of said mathematical program that are referenced in rules identified by said locating process; and
means for reporting equations that contain at least one of broken chains and that have a measure outside a predetermined limit based on said examining process.
